(19) United States
(12) Patent Application Publication
(10) Pub. No.: US 2017/0001170 A1
(43) Pub. Date: Jan. 5, 2017

(54) METHOD, SYNTHESIS, ACTIVATION PROCEDURE AND CHARACTERIZATION OF AN OXYGEN RICH ACTIVATED POROUS CARBON SORBENT FOR SELECTIVE REMOVAL OF CARBON DIOXIDE WITH ULTRA HIGH CAPACITY

(71) Applicants: William Marsh Rice University, Houston, TX (US); Apache Corporation, Houston, TX (US)

(72) Inventors: Saunab Ghosh, Houston, TX (US); Andrew R. Barron, Houston, TX (US); Jason Ho, Houston, TX (US)

(73) Assignees: William Marsh Rice University, Houston, TX (US); Apache Corporation, Houston, TX (US)

(21) Appl. No.: 15/200,632

(22) Filed: Jul. 1, 2016

Related U.S. Application Data
(60) Provisional application No. 62/187,744, filed on Jul. 1, 2015.

(51) Int. Cl. B01J 20/20; C10L 3/10; B01J 20/30; B01D 53/04; C01B 31/12; B01J 20/28

(52) U.S. Cl. CPC B01J 20/20; C01B 31/12; B01J 20/28066; B01J 20/28076; B01J 20/3078; B01D 53/04; C10L 3/104; C10L 2290/541

(57) ABSTRACT

The present disclosure pertains to materials for CO₂ adsorption at pressures above 1 bar, where the materials include a porous carbon material with a surface area of at least 2800 m²/g, a total pore volume of at least 1.35 cm³/g, and a carbon content of 80%-95%. The porous carbon material is prepared by heating organic polymer precursors or biological materials in the presence of KOH at 700° C.-800° C. The present disclosure also pertains to materials for the separation of CO₂ from natural gas at partial pressures above 1 bar, where the material includes a porous carbon material with a surface area of at least 2000 m²/g, a total pore volume of at least 1.00 cm³/g, and a carbon content of greater than 90%. The porous carbon materials can be prepared by heating organic polymer precursors or biological materials in the presence of KOH at 600° C.-700° C.

### CROSS-REFERENCE TO RELATED APPLICATIONS

This application claims priority to U.S. Provisional Patent Application No. 62/187,744, filed on Jul. 1, 2016. The entirety of the aforementioned application is incorporated herein by reference.

### STATEMENT REGARDING FEDERALLY SPONSORED RESEARCH

Not applicable.

### BACKGROUND

Current materials for capturing carbon dioxide (CO₂) suffer from numerous limitations, including limited CO₂ sorption capacity and selectivity. Various embodiments of the present disclosure address these limitations.

### SUMMARY

In some embodiments, the present disclosure pertains to materials for CO₂ adsorption at pressures above 1 bar. In some embodiments, the materials include a porous carbon material with a surface area of at least 2800 m²/g, a total pore volume of at least 1.35 cm³/g, and a carbon content of between 80% and 95% as measured by X-ray photoelectron spectroscopy. In some embodiments, the porous carbon material is prepared by heating an organic polymer precursor or biological material in the presence of potassium hydroxide (KOH). In some embodiments, the temperature of activation is between 700° C. and 800° C.

In additional embodiments, the present disclosure pertains to materials for the separation of CO₂ from natural gas at partial pressures of either component above 1 bar. In some embodiments, the materials include a porous carbon material with a surface area of at least 2000 m²/g, a total pore volume of at least 1.00 cm³/g, and a carbon content of greater than 90% as measured by X-ray photoelectron spectroscopy. In some embodiments, the porous carbon material is prepared by heating an organic polymer precursor or biological material in the presence of KOH. In some embodiments, the temperature of activation is between 600° C. and 700° C.

The porous carbon materials of the present disclosure can be prepared in various manners. For instance, in some embodiments, the porous carbon materials of the present disclosure are prepared by heating an organic polymer precursor. In some embodiments, the organic polymer precursor includes oxygen in a functional group. In some embodiments, the functional group is a furyl. In some embodiments, the organic polymer precursor is furfuryl alcohol. In some embodiments, the organic polymer precursor polymerizes to form polyfurfuryl alcohol (PFA). In some embodiments, PFA is prepared by the polymerization of furfuryl alcohol with a catalyst. In some embodiments, the catalyst is iron(III) chloride.

In some embodiments, the porous carbon materials of the present disclosure are prepared by heating a biological material. In some embodiments, the biological material includes, without limitation, sawdust, coconut husk, and combinations thereof.

Additional embodiments pertain to methods of making the materials of the present disclosure. Further embodiments pertain to utilizing the materials of the present disclosure for the capture of CO₂ from various environments.

### DESCRIPTION OF THE FIGURES

FIG. 1 provides data relating to high pressure CO₂ uptake (at 30 bar and 24° C.) as a function of the surface area (FIG. 1A) and total pore volume (FIG. 1B), for a range of porous carbons (PCs), including N-containing PCs (NPCs) and S-containing PCs (SPCs).

FIG. 2 provides a plot of CO₂ uptake at 30 bar and 24° C. as a function of activation temperature for PC NPC and SPC samples.

FIG. 3 provides estimated surface area (FIG. 3A) and total pore volume (FIG. 3B) as a function of activation temperature for PC, NPC and SPC samples.

FIG. 4 provides comparative data relating to CO₂ uptake as a function of CO₂ pressure on N-containing polymer polypyrrole (PPy) precursors and PPy precursors activated at different temperatures (PPy-T-2). Sorption measurements were performed at 24° C.

FIG. 5 provides N₂ adsorption isotherms for four different NPC samples of PPy-T-2 prepared from polypyrrole and activated at the labelled temperature (T). Sorption measurements were performed at 24° C.

FIG. 6 provides data relating to the determination of pore structures by N₂ physisorption isotherms of PPy-T-2 samples activated at different temperatures by N₂ physisorption isotherms. Shown are the estimated surface area (FIG. 6A) and total pore volume (FIG. 6B) versus activation temperature.

FIG. 7 shows the pore size distributions of PPy-T-2 samples prepared at the three activation temperatures shown, as determined by the non-local density functional theory (NLDFT) method.

FIG. 8 shows high pressure (30 bar) CO₂ uptake as a function of N wt % (FIG. 8A) and S wt % (FIG. 8B) in NPC and SPC samples, respectively. Sorption measurements were performed at 24° C.

FIG. 9 shows high pressure (30 bar) CO₂ uptake as a function of 0 wt % (FIG. 9A) and Σ(O, N, S) wt % (FIG. 9B) in PC, NPC and SPC samples. Sorption measurements were performed at 24° C.

FIG. 10 shows room temperature volumetric CO₂ (FIG. 10A) and methane (CH₄) (FIG. 10B) adsorption isotherms for PC, NPC, and SPC samples. FIG. 10C shows the molar CO₂:CH₄ uptake ratio as a function of gas pressure for PC, NPC, and SPC samples.

FIG. 11 shows plots of molar CO₂:CH₄ uptake ratio (@ 30 bar) as a function of the surface area (FIG. 11A) and total pore volume (FIG. 11B) for a range of PC, NPC and SPC samples. Sorption measurements were performed at 24° C.

FIG. 12 shows plots of molar CO₂:CH₄ uptake ratio (@ 30 bar) as a function of the surface area (FIG. 12A), total pore volume (FIG. 12B), activation temperature (FIG. 12C), and CO₂ uptake (FIG. 12D) for PPy-T-2 (T=500, 600, 700 and 800° C.) NPC samples. Sorption measurements were performed at 24° C.

FIG. 13 shows high pressure (30 bar) molar CO₂:CH₄ uptake ratio as a function of N wt % in NPC samples. Sorption measurements were performed at 24° C.

FIG. 14 shows the high pressure (30 bar) molar CO₂:CH₄ uptake ratio as a function of C wt % in PC, NPC, and SPC samples. Sorption measurements were performed at 24° C.

FIG. 15 shows volumetric CO₂ uptake of different OPCs activated at increasing temperature, activated carbon and carbon precursor.

FIG. 16 provides an analysis of the porous structure of OPC samples activated at different temperatures. FIG. 16A shows N₂ adsorption and desorption isotherms for a PC (800) sample. FIG. 16B shows estimated surface area and total pore-volume vs. activation temperature. FIG. 16C shows the distribution of pore volumes as a function of activation temperature as estimated by NLDFT. FIG. 16D shows the surface area (blue bars) and total pore volume (purple) for activated charcoal and eight different PC samples known for high CO₂ uptakes (>14 mmol g⁻¹ at 30 bar).

FIG. 17 provides additional data relating to the CO₂ uptake of porous carbons. FIG. 17A shows the volumetric CO₂ uptake of various porous carbons prepared from different carbon precursors, including O-rich PC (OPC), N-rich PC (NPC) and S-rich PC (SPC). Measurements were performed in a PCTPRO instrument at 24° C. FIG. 17B shows the graphical representation of surface areas and maximum CO₂ uptake capacities at 30 bar for nine different porous carbon sorbents. The highest CO₂ uptake property (26.6 mmol g⁻¹) is demonstrated by Applicants' newly discovered OPC (750) sample (second bar to the right).

FIG. 18 provides a demonstration of optimal gas uptake selectivity of OPC samples for CO₂ over CH₄. FIG. 18A shows volumetric CO₂ and CH₄ uptake measurements on OPC (750) sorbents up to a pressure range of 30 bar at 0.5 and 24° C. FIG. 18B shows volumetric CO₂ and CH₄ uptake measurements on commercially available activated charcoal. The molar uptake ratios (CO₂/CH₄) at 30 bar for OPC(750) and activated charcoal are 2.74 and 1.4, respectively.

FIG. 19 provides a demonstration of optimal gas uptake selectivity of OPC samples for CO₂ over CH₄. Volumetric CO₂ and CH₄ uptake measurements on OPC (750) sorbents up to a pressure range of 30 bar at 0.5° C. and 24° C. are shown. The mass uptake ratios (CO₂/CH₄) at 30 bar for OPC(750) are 8.0 and 7.6, respectively.

FIG. 20 provides a demonstration of the reproducibility of sample preparation and gas uptake properties of OPCs. FIG. 20A shows volumetric CO₂ uptake measurements on four different OPC (750) samples synthesized and activated the same way. FIG. 20B shows two successive CO₂ adsorption and desorption cycles.

FIG. 21 provides various schemes and data relating to the synthesis and characterization of OPCs. FIG. 21A provides a synthesis scheme for OPC. Photographs of carbon precursor (FIG. 21B), as-synthesized OPC (FIG. 21C), and as-synthesized SPC samples (FIG. 21D) are also shown. OPC samples are pellet like compared to SPC and other PC materials. Scanning electron microscopy (SEM) images of carbon precursor (FIG. 21E), OPC (600) (FIG. 21F) and OPC (800) samples (FIG. 21G) are also shown. FIG. 21H shows an energy-dispersive X-ray spectroscopy (EDS) elemental scan for OPC (800). Also shown are high resolution transmission electron microscopy (TEM) images of OPC (600) (FIG. 21I) and OPC (800) samples (FIG. 21J) showing nm sized micro porous structures.

FIG. 22 shows the isostreric heat of absorption of CO₂ (FIG. 22A) and CH₄ (FIG. 22B) as a function molar gas uptakes.

FIG. 23 shows the characterization of chemical compositions of carbon precursor and porous carbon samples activated at increasing temperatures. Shown are X-ray photoelectron spectroscopy (XPS) survey scans for C-precursor (FIG. 23A) and OPC (800) (FIG. 23B). Also shown are the wt % of elemental carbon (FIG. 23C) and oxygen (FIG. 23D) vs. activation temperature. XPS elemental scanning for carbon C1s (FIG. 23E) and oxygen O1s (FIG. 23F) are also shown. FIG. 23G shows the Fourier transform infrared spectroscopy (FTIR) spectra of C-precursor and activated OPCs. FIG. 23H shows the Raman spectra and Raman disorder (D) to graphene (G) band intensity ratio vs. activation temperature. KOH/Polymer weight ratio=3 in all cases. IR spectra are base line corrected and vertically offset for clarity.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

There are generally two classes of materials employed for carbon dioxide (CO₂) separation: reactants and adsorbents. The former includes amine and other reactive species such as ionic liquids and alkali-metal-based oxides. At present, monoethanolamine (MEA) is the industry standard. However, regeneration, degradation and corrosion, together with health and environmental issues, still affect its large scale implementation.

Impregnation of CO₂ capture materials onto supports has been investigated, but it is only recently that the regeneration temperature has been lowered by their combination with carbon nanomaterials. Ionic liquids, suitable for high pressure capture are expensive and toxic, while cheap alkali metal oxides suffer from severe deactivation upon cycling.

Although the aforementioned materials show optimal selectivity between CO₂ and methane (CH₄), their myriad drawbacks have meant that much effort has been invested into the study of solid porous sorbents, such as porous carbons (PC), metal-organic frameworks (MOFs), microporous zeolites, and porous silica-based sorbents with high surface area.

MOFs outperform zeolites in terms of maximum capacity at high pressure, but are expensive since they require complex multistep synthesis procedures. In addition, their gas adsorption capacity degrades after several cycles of usage. Carbonaceous materials, such as activated carbon and charcoal, are cheaper and less sensitive to moisture than zeolites and MOFs, but their adsorption capacity generally increases with loss of selectivity at high pressure.

Chemically activated porous carbon adsorbents have large surface areas and pore volumes associated with micro- and meso-porous structure. As a result, such materials show significantly improved CO₂ capturing capacity as compared to traditional carbonaceous materials.

It has been suggested that the presence of nitrogen or sulphur dopants is responsible for improved CO₂ uptake in porous carbon materials (e.g., Nat Commun., 2014, 5, 3961 and U.S. Pat. Pub. No. 2015/0111024). These studies were undertaken at 30 bar (1 bar=100,000, Pa=750.06 mmHg) using compounds previously reported to show improved results over activated carbon at 1 bar (e.g., Adv. Funct. Mater., 2011, 21, 2781-2787; and Microporous Mesoporous Mater., 2012, 158, 318-323). The improved high pressure results were proposed to be due to the S or N centers acting as a Lewis base to facilitate the ambient polymerization of the CO₂. However, previous investigations of the role of N-doping in CO₂ capture by PCs up to 1 bar pressure shows no correlation (e.g., ACS Appl. Mater. Interfaces, 2013, 5, 6360-6368).

The conventional goal in synthesizing a porous carbon material with optimal CO₂ adsorption is to focus on increased surface area and pore volume (e.g., U.S. Pat. Pub. No. 2016/0136613). The same approach is presumed to also work for the separation of CO₂ from natural gas.

However, the present disclosure demonstrates that increasing the surface area and pore volume of a carbon material do not guarantee the best adsorbent. Instead a combination of factors is involved in defining the ideal porous carbon absorbent material.

In some embodiments, the present disclosure pertains to novel materials for CO₂ capture. In additional embodiments, the present disclosure pertains to methods of making the materials of the present disclosure. In further embodiments, the present disclosure pertains to methods of utilizing the materials of the present disclosure for the capture of CO₂ from various environments. As set forth in more detail herein, the present disclosure can have various embodiments.

Materials for CO₂ Capture

In some embodiments, the present disclosure pertains to materials for CO₂ adsorption at pressures above 1 bar. In some embodiments, the materials include a porous carbon material with a surface area of at least 2800 m²/g, a total pore volume of at least 1.35 cm³/g, and a carbon content of between 80% and 95% as measured by X-ray photoelectron spectroscopy. In some embodiments, the porous carbon material is prepared by heating an organic polymer precursor or biological material in the presence of potassium hydroxide (KOH). In some embodiments, the temperature of activation is between 700° C. and 800° C.

In additional embodiments, the present disclosure pertains to materials for the separation of CO₂ from natural gas at partial pressures of either component above 1 bar. In some embodiments, the materials include a porous carbon material with a surface area of at least 2000 m²/g, a total pore volume of at least 1.00 cm³/g, and a carbon content of greater than 90% as measured by X-ray photoelectron spectroscopy. In some embodiments, the porous carbon material is prepared by heating an organic polymer precursor or biological material in the presence of KOH. In some embodiments, the temperature of activation is between 600° C. and 700° C.

In some embodiments, the materials of the present disclosure are rich in oxygen. As such, in some embodiments, the materials of the present disclosure are referred to as oxygen rich activated porous carbons (OPCs). In some embodiments, the materials of the present disclosure have an oxygen content of more than about 10 wt %. In some embodiments, the materials of the present disclosure have an oxygen content between about 10 wt % and about 25 wt %.

In some embodiments, the materials of the present disclosure may lack other heteroatoms, such as nitrogen or sulfur. For instance, in some embodiments, the total heteroatom content of the materials of the present disclosure may range from about 0 wt % to about 1 wt %. In some embodiments, the total heteroatom content of the materials of the present disclosure may be less than about 1 wt %.

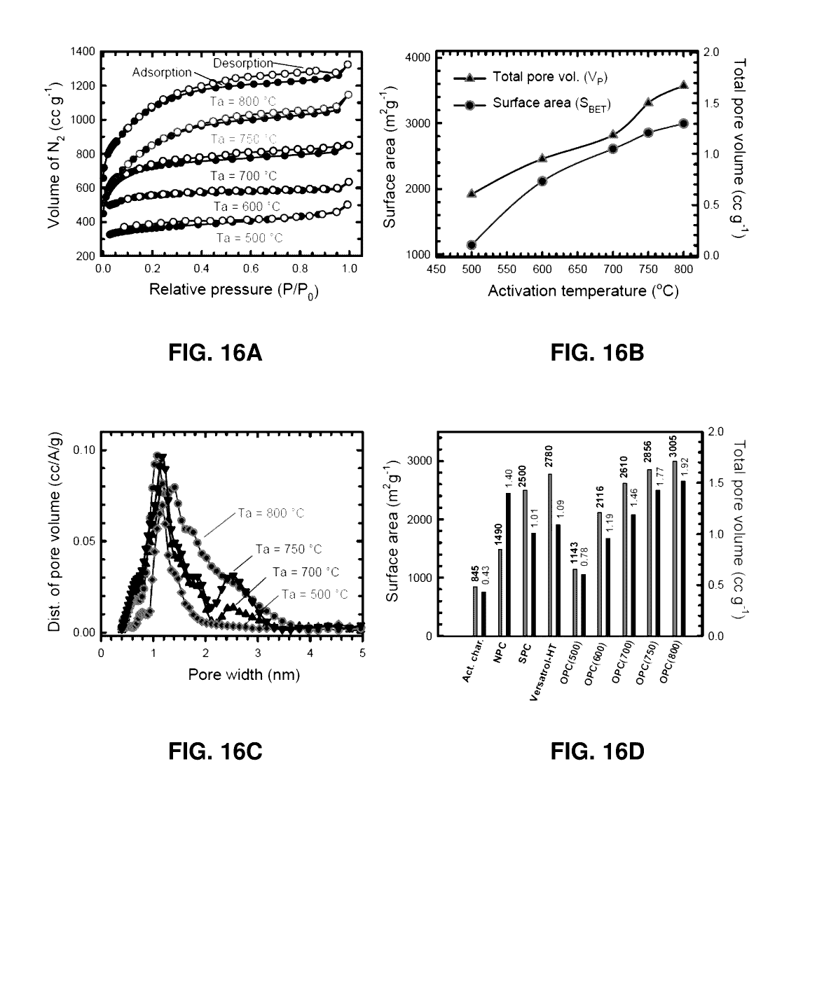

The materials of the present disclosure can have various advantageous properties. For instance, in some embodiments, the materials of the present disclosure have high surface areas. In some embodiments, the materials of the present disclosure have surface areas of more than about 1,000 m²/g. In some embodiments, the materials of the present disclosure have surface areas that range from about 1,000 m²/g to about 5000 m²/g (Table 5). In some embodiments, the materials of the present disclosure have surface areas of about 3005 m²/g (e.g., in OPC samples chemically activated at 800° C.) (FIG. 16D).

In some embodiments, the materials of the present disclosure have high CO₂ adsorption capacities. In some embodiments, the materials of the present disclosure have a CO₂ adsorption capacity of more than about 100 wt %. In some embodiments, the materials of the present disclosure have CO₂ adsorption capacities between about 117 wt % and about 189 wt %.

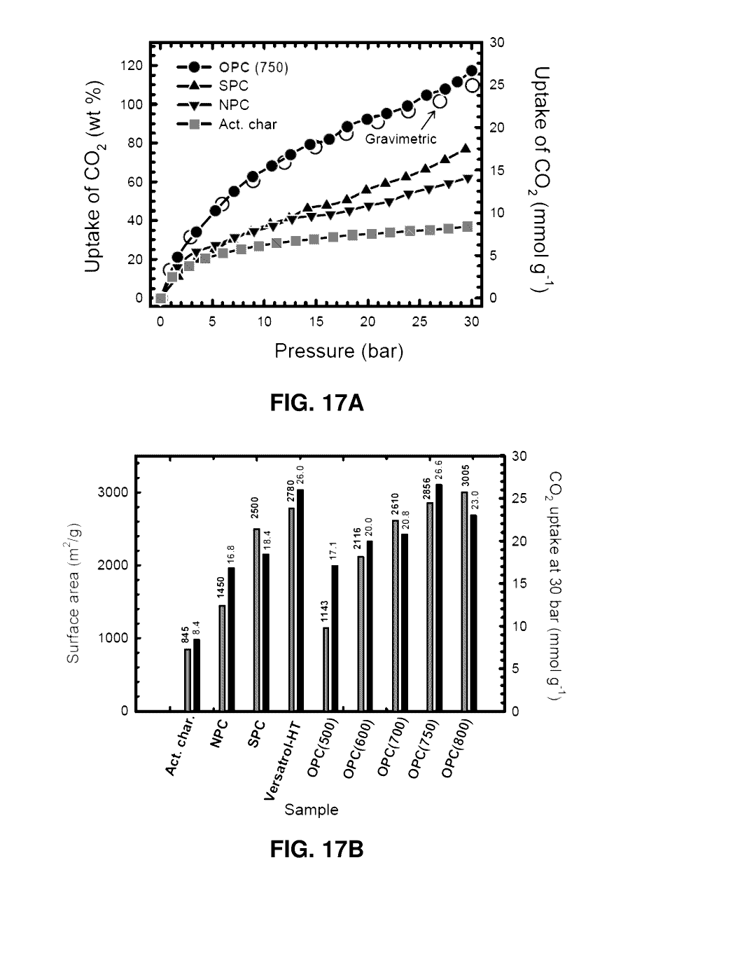

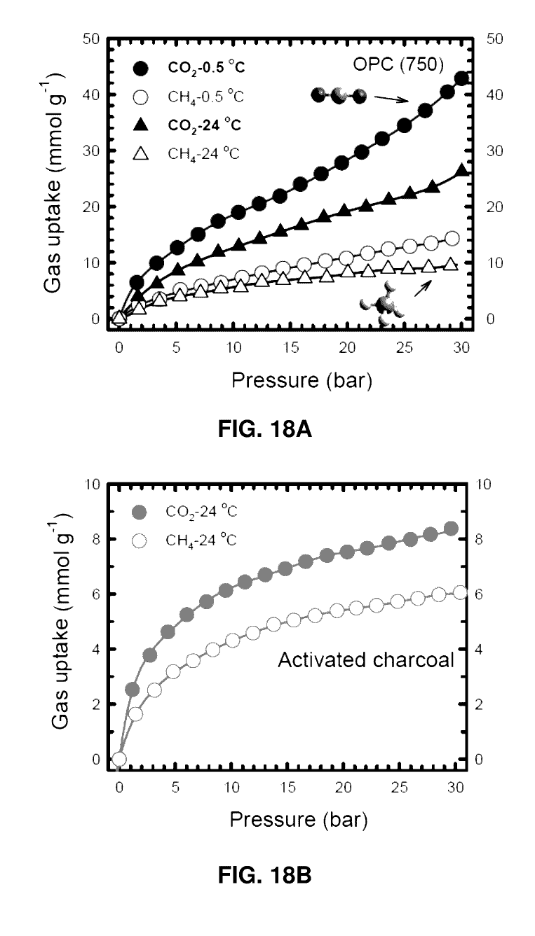

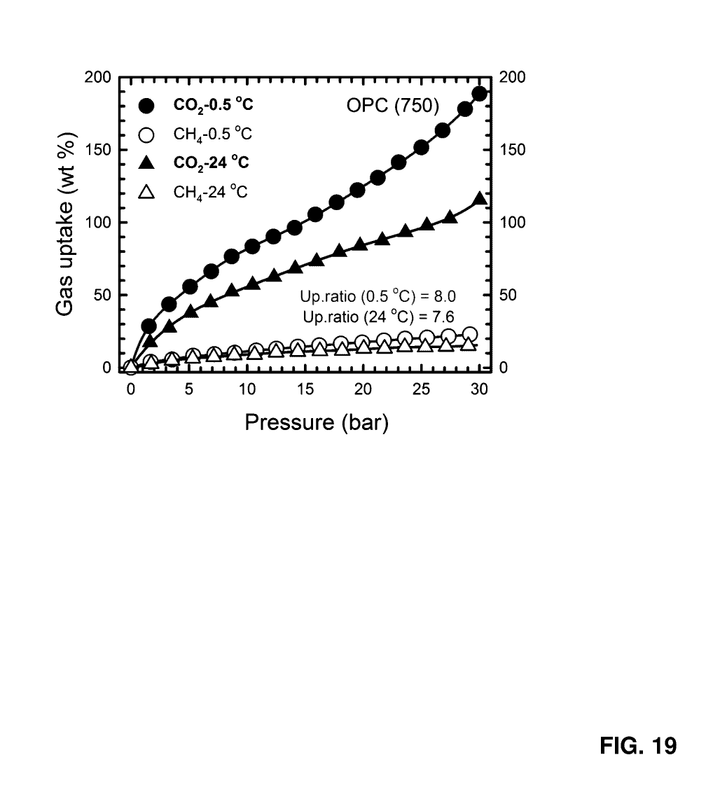

In some embodiments, the materials of the present disclosure have a CO₂ adsorption capacity of up to 117 wt % (26.6 mmol/g) at a pressure of 30 bar, a number that is higher than any reported uptake values for activated porous carbon (PC) adsorbents (FIG. 17 and Table 5). In some embodiments, the materials of the present disclosure capture CO₂ from a natural gas containing environment that is rich in CH₄ at a maximum molar uptake ratio of 2.75 (7.5 by mass ratio) at a pressure of 30 bar (FIGS. 18-19).

In some embodiments, the materials of the present disclosure (e.g., OPCs that are activated at 750° C., referred to herein as OPC (750)) outperform most of the existing porous carbons for high pressure uptake of CO₂ (e.g., 26.6 mmol/g; 117 wt % at 30 bar) and demonstrate optimal selectivity for CO₂ capture over CH₄ uptake (e.g., V_{CO2}/V_{CH4} ratio ˜2.7 (molar) and ˜7.5 (by wt) at 30 bar) at room temperature. Additionally, OPC (750) demonstrates ultrahigh CO₂ uptake (43 mmol g⁻¹; 189 wt %) at 0.5° C., a value that was never reported previously (FIG. 18A).

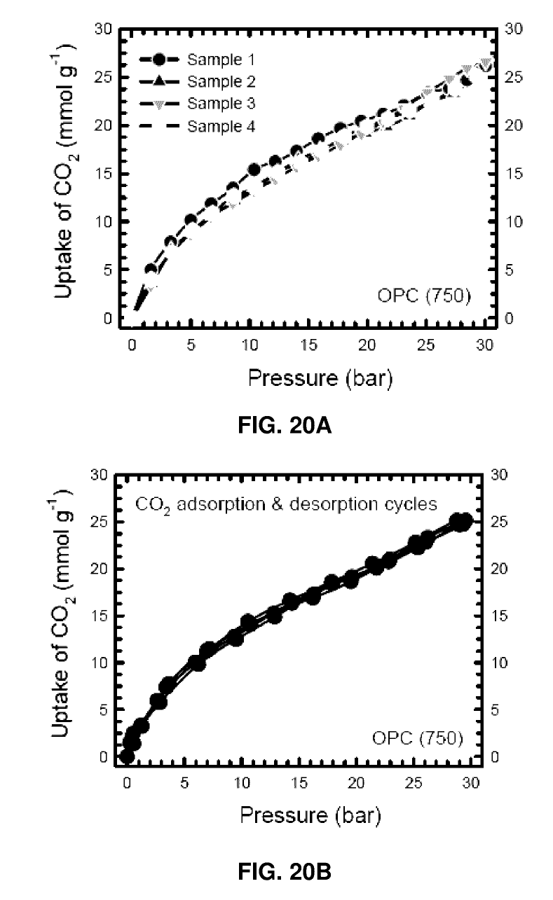

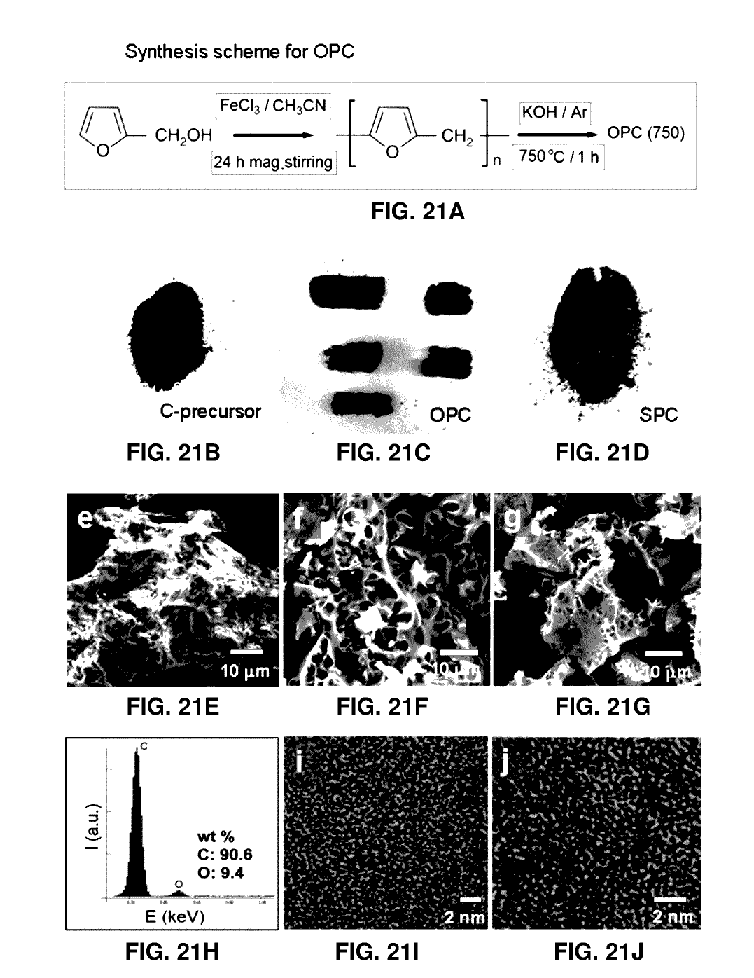

In some embodiments, the materials of the present disclosure exhibit remarkable thermal stability and reproducible gas uptake properties for many cycles (FIG. 20). Unlike other fine powder type activated porous carbon materials, the materials of the present disclosure can be clumpy and pelletized in some embodiments. Such properties can in turn make the materials of the present disclosure better candidates for preparing solid pellet-like adsorbents (FIG. 21C).

Formation of Materials

The materials of the present disclosure can be prepared in various manners. Additional embodiments of the present disclosure pertain to methods of making the materials of the present disclosure.

In some embodiments, a carbon precursor is first synthesized. Next, the carbon precursor is activated to form porous carbon materials. Various methods may be utilized to optimize sample preparation to synthesize activated porous carbon materials with very high CO₂ uptake.

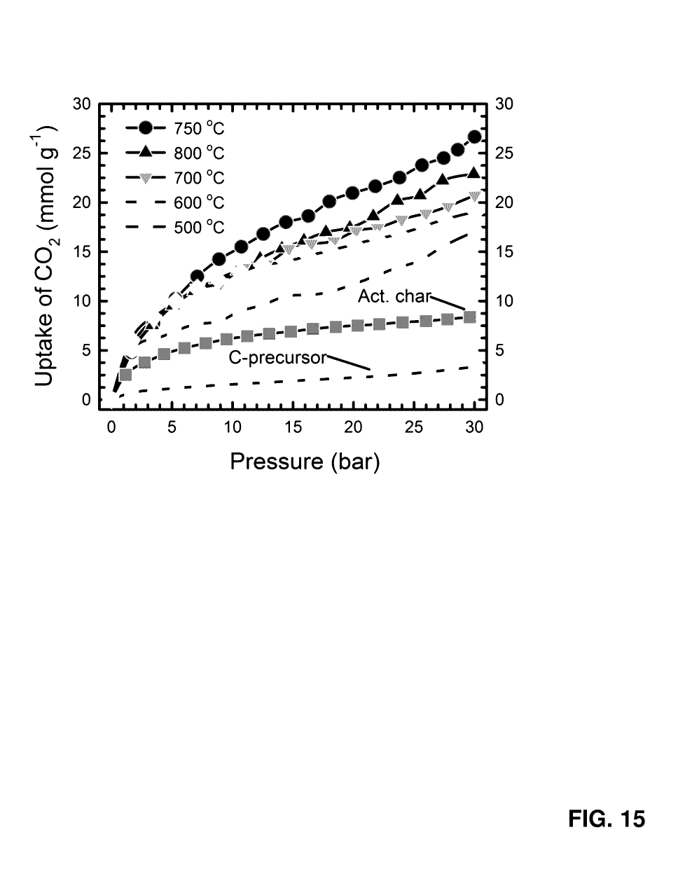

In some embodiments, a carbon precursor is activated by chemical activation. In some embodiments, the chemical activation includes heating the carbon precursor in a mixture. In some embodiments, the carbon precursor is heated in a mixture that contains a base, such as KOH. In some embodiments, the heating temperature ranges from about 500° C. to about 800° C. (FIG. 15). In some embodiments, the activation temperature is about 750° C.

In some embodiments, the carbon precursor is synthesized by polymerizing a carbon source. In some embodiments, the polymerization occurs by exposing the carbon source to an oxidant, such as iron (III) chloride (FeCl₃) in the presence of acetonitrile (CH₃CN).

In some embodiments, the materials of the present disclosure are prepared from affordable and readily available carbon sources. In some embodiments, the carbon sources include oxygen-containing carbons. In some embodiments, the oxygen containing carbon sources are rich in alcohol. In some embodiments, the carbon sources lack heteroatoms such as nitrogen, sulfur, and combinations thereof. As such, in some embodiments, the formed materials of the present disclosure also lack such heteroatoms.

In some embodiments, the materials of the present disclosure are prepared by heating a biological material. In some embodiments, the biological material includes, without limitation, sawdust, coconut husk, and combinations thereof.

In some embodiments, the carbon source that is utilized to make the materials of the present disclosure is furfuryl alcohol (FFA) (purchasable from Sigma Aldrich at a price of $354 for 25 kg with purity>98%) (Table 4). In some embodiments where the carbon source is FFA, the formed carbon precursor is polyfurfuryl alcohol (PFFA).

In some embodiments, the materials of the present disclosure are prepared by heating an organic polymer precursor. In some embodiments, the organic polymer precursor includes oxygen in a functional group. In some embodiments, the functional group is a furyl. In some embodiments, the organic polymer precursor is FFA. In some embodiments, the organic polymer precursor polymerizes to form polyfurfuryl alcohol (PFFA). In some embodiments, PFFA is prepared by the polymerization of furfuryl alcohol with a catalyst. In some embodiments, the catalyst is FeCl₃.

A more specific method of making the materials of the present disclosure is illustrated in FIG. 21A. In this illustration, the FFA is polymerized by using FeCl₃ as the oxidant. In a typical synthesis, a solution of FeCl₃ is prepared by solubilizing FeCl₃ in CH₃CN. FFA is then mixed with CH₃CN and slowly added to the FeCl₃ solution. The mixture is then magnetically stirred for 24 hours at room temperature. The polymerized product, brown colored PFFA, is then separated by filtration over a sintered glass funnel, washed thoroughly with abundant distilled water, and then with acetone. This is followed by drying at 40° C. for 12 hours. The yield of the final product was ˜98%.

Next, the porous carbon was chemically activated by heating a PFFA-KOH mixture (KOH/PFFA at a weight ratio of 3) in inert atmosphere. The mixture was then placed inside a quartz tube/tube furnace setup and heated for 1 hour at a fixed temperature in the 500-800° C. range, under a flow of Ar. The activated OPC sample was then thoroughly washed several times with diluted HCl and distilled water and dried on a hot plate at 70° C. for 12 hours.

In some embodiments, the KOH/PFFA ratio can be varied. In some embodiments, the activation temperatures and the PFFA-KOH mixing procedure can be varied.

Use of Materials for Gas Capture

The materials of the present disclosure can be utilized to capture and selectively remove various gases (e.g., CO₂, CH₄, and combinations thereof) from various environments. Additional embodiments of the present disclosure pertain to methods of utilizing the materials of the present disclosure for the separation of a mixture of gases by preferential adsorption and selective desorption. Further embodiments of the present disclosure pertain to methods of utilizing the materials of the present disclosure for the capture of CO₂ from various environments. In some embodiments, the environments include an atmosphere or an environment that contains a mixture of gases. In some embodiments, the methods of the present disclosure pertain to processes for separating CO₂ from natural gas by exposing the natural gas to the materials of the present disclosure.

In some embodiments, the methods of the present disclosure utilize the materials of the present disclosure in a process in which selectivity and separation of two gases (such as CH₄ and CO₂) is accomplished by a combination of an adsorption process that favors one of the components (e.g., selectivity of CO₂ over CH₄). Thereafter, the desorption of the two components from the carbon materials can be significantly different by control over various parameters, such as temperature, pressure, and combinations thereof. In some embodiments, such control allows for the specific desorption of one of the components prior to the other (e.g., CH₄ over CO₂). In some embodiments, the overall process allows for the selective separation of at least two gaseous components.

In some embodiments, the materials of the present disclosure differentiate between CH₄ and CO₂ adsorption as well as desorption. In some embodiments, the selectivity of adsorption is further enhanced since the pressure/temperature dependencies of the desorption of CH₄ and the desorption of CO₂ are distinct from each other such that they may be used to improve separation. Thus, in some embodiments, a mixture of adsorbed CH₄ and CO₂ will desorb under different conditions: the CH₄ first and the CO₂ second. In some embodiments, this difference means that the overall adsorption/desorption selectivity of CH₄ and CO₂ is higher than prior materials.

In some embodiments, the materials of the present disclosure can be used for the selective capture of CO₂ from various environments. In some embodiments, the materials of the present disclosure can be utilized for the selective capture of CO₂ over hydrocarbons in the environment (e.g., CH₄). In some embodiments, the adsorption of CO₂/CH₄ mixtures and measurement of the desorption selectivity can be varied.

Applications and Advantages

The methods and materials of the present disclosure can provide numerous advantages. For instance, in some embodiments, the methods and materials of the present disclosure can be utilized for the selective removal of CO₂ from natural gas (e.g., methane) that contains various amounts of CO₂ (e.g., 10-20 mol % of CO₂). Such an application is an important goal in the field of oil and natural gas, since contaminant CO₂ decreases its power efficiency. For an ideal gas adsorbing material, the major requirements are as follows: it should be cheap, simple to synthesize, demonstrate reproducible and high gas uptake property, and complete desorption of CO₂ at low pressure. In various embodiments, the materials of the present disclosure possess all of these properties.

In some embodiments, the methods and materials of the present disclosure can be utilized for the separation of CO₂ from natural gas at a source where low to medium levels of CO₂ are present. In some embodiments, the methods and materials of the present disclosure can be used as a secondary recovery method for treating CH₄/CO₂ mixtures in which CO₂ is the major component. In some embodiments, such mixtures include high-pressure samples that are the result of an initial CH₄/CO₂ separation using traditional methods.

The materials of the present disclosure can also provide numerous advantages. In particular, among the most efficient solid sorbents for capturing CO₂ from natural gas or atmosphere, MOFs and KOH aided chemically activated PC materials with large surface areas and micro pores have been investigated for decades. PC composites demonstrate remarkable thermal stability and repeatability for selective gas uptake measurements.

However, to date, most of the researchers have synthesized porous carbons from carbon rich precursors that contain heteroatoms, such as nitrogen or sulfur. For sulfur rich precursors, the most common feedstock for synthesizing PCs are polythiophene or poly(2-thiophenemethanol), whereas, pyrrole of acrylonitrile are being utilized for the production of nitrogen containing PCs.

Unfortunately, the high cost of both chemicals hinders the industrial scale use of PCs produced from these materials. Based upon an analysis of the best PC materials in terms of selectivity and CO₂ uptake, Applicants have noted that the common link is not the presence of strong Lewis base species such as N or S, but the presence of oxygen. Thus, Applicants envision that oxygen is an important component for selectivity and high adsorption of gases (e.g., CO₂ and/or CH₄) in the materials of the present disclosure.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Preparation of Porous Carbon Materials

This Example provides processes for the preparation of various porous carbon materials.

### Example 1.1

### Synthesis of Activated Porous Carbon (PC) from Coconut Shell

Pieces of dry coconut shell were placed inside a quartz tube/tube furnace setup and carbonized for 1 hour at 450° C., under a flow of Ar (flow rate 500 sccm). The carbonized product (500 mg) was thoroughly mixed with potassium hydroxide (KOH) powder (1.0 g). The mixture was then placed inside a quartz tube/tube furnace setup, dried for 20 minutes and then heated for 1 hour at a fixed temperature of 600° C. under continuous flow of Argon (flow rate of about 600 sccm), washed with distilled water (ca. 4 L) and then with acetone (ca. 1 L) and dried at 80° C. for 12 hours.

### Example 1.2

### Synthesis of Nitrogen-Containing Porous Carbon (NPC) from Polypyrrole

The polymerized carbon precursor polypyrrole was synthesized using FeCl₃ as a catalyst following a modification of Applicants' previous methods. In a typical synthesis, a solution of FeCl₃ (50 g) in CH₃CN (200 mL) was prepared. Next, a solution of pyrrole (5.0 g) in CH₃CN (50 mL) was slowly added to the previous solution. The mixture was stirred for 24 hours. The polymerized product was then separated by filtration, washed thoroughly with distilled water (ca. 4 L) and then with acetone (ca. 1 L) and dried at 80° C. for 12 hours. The yield of the final product was ˜98%. The polypyrrole was chemically activated by heating with an excess (2 or 4 fold by weight) of KOH in inert atmosphere. In a typical activation process, polypyrrole (500 mg) was thoroughly mixed with KOH (1.0 g) that had been crushed to a fine powder in a mortar. The mixture was then placed inside a quartz tube within a tube furnace, dried for 20 minutes and then heated for 1 hour at a fixed temperature in the 500-800° C. range, under a flow of Ar (flow rate 600 sccm). The activated samples were then thoroughly washed with diluted HCl (1.4 M, 100 mL) and several times with distilled water until the filtrate attained neutral pH 7. Finally, the activated PC was dried on a hot plate at 70° C. for 12 hours.

### Example 1.3

### Synthesis of Polyfurfuryl Alcohol (PFFA)

In a typical synthesis, a solution was prepared by dissolving FeCl₃ (50 g) in CH₃CN (200 mL). To this a solution of furfuryl alcohol (5 g, Sigma Aldrich, 98%) mixed with CH₃CN (50 mL) was slowly added. The mixture was stirred for 24 hours under continuous argon purging. The polymerized product, brown colored polyfurfuryl alcohol (PFFA) was separated by filtration, washed thoroughly with DI water (ca. 4 L) and acetone (500 mL), before being dried at 40° C. for 12 hours under vacuum (Yield=98%).

### Example 1.4

### Conversion of PFFA to Oxygenated Porous Carbon (OPC)

In a typical activation process, PFFA (500 mg) was thoroughly mixed with KOH powder (1.5 g, crushed previously) in a mortar for 10 minutes. The mixture was then placed inside a quartz tube/tube furnace, dried for 20 minutes and then heated for 1 hour at 500, 600, 700 or 750° C., under a flow of Ar (99.9%, flow rate 600 sccm). The activated samples were then washed with HCl (100 mL, 1.4 M) and DI water until the filtrate attained pH=7. The product was dried at 70° C. for 12 hours under vacuum. The yield of activated PC materials depended on the activation temperature: OPC₅₀₀=55%, OPC₆₀₀=40%, OPC₇₀₀=30%, and OPC₇₅₀=25-27%.

### Example 2

### Characterization of the Porous Carbon Materials

This example provides various data relating to the characterization of the porous carbon materials in Example 1.

The volumetric uptake measurements (sorption and desorption) of CO₂ and CH₄ by the porous carbons were performed in an automated Sievert instrument (Setaram PCTPRO). Various PC samples were first crushed into powders and packed in a stainless steel autoclave sample cell. Initial sample pre-treatment was carried out at 130° C. for 1.5 hours under high vacuum. The free volume inside the sample cell was determined by a series of calibration procedures done under helium. Gas uptake experiments were carried out with high purity research grade CO₂ (99.99%) and CH₄ (99.9%) at 24° C.

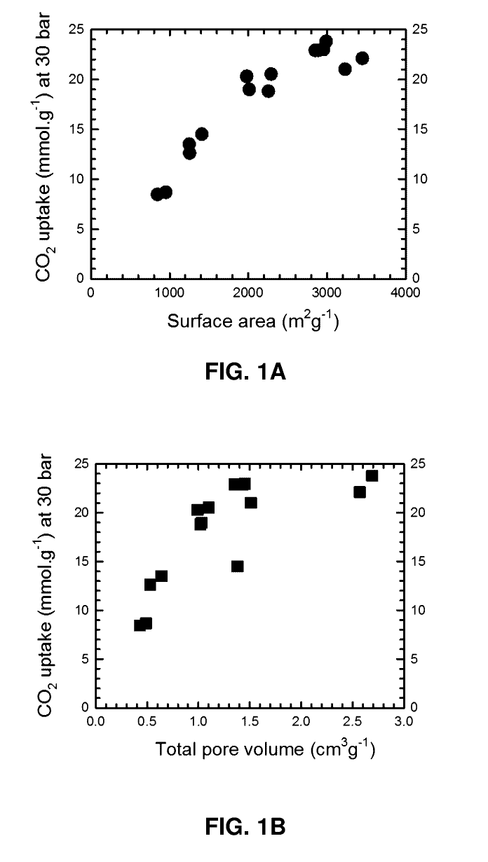

FIG. 1A shows a plot of the uptake of CO₂ at 30 bar as a function of the apparent Brunauer-Emmett-Teller (BET) surface area (S_{BET}) for all the PC adsorbent measured. As expected, an increase in surface area correlates with an increase in CO₂ uptake. However, any value above 2800 m²g⁻¹ does not appear to improve adsorption. Thus, continued attempts to create even higher surface area materials may not result in any further improvements in CO₂ uptake.

It is envisioned that increased total pore volume (Vₚ) will facilitate increased CO₂ adsorption. However, as shown in FIG. 1B, it appears that for pore volumes over 1.35 cm³g⁻¹, there is not a resulting greater uptake.

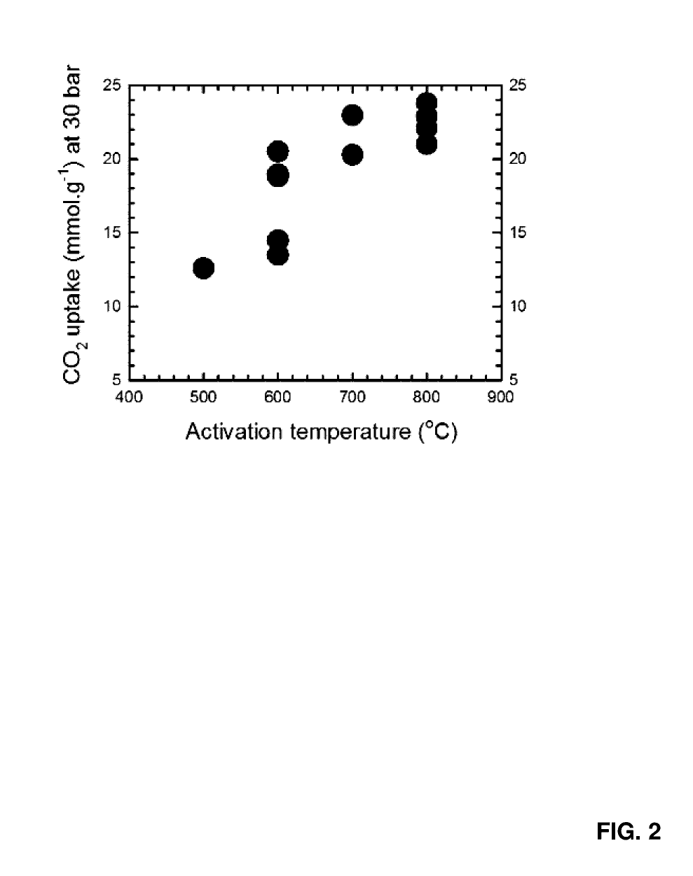

FIG. 2 shows the relationship between the activation temperature and the CO₂ uptake for the porous carbon samples listed in Table 1. The general trend is increasing uptake with increased activation temperature with a possible maximum between 700 and 800° C.

TABLE 1
Summary of PC, NPC, and SPC samples studied with their elemental analysis,
physical properties and CO₂ uptake.

| | | | | | Surface | Total pore | |
|---|---|---|---|---|---|---|---|
| | C | O | N | S | area | volume | CO₂ uptake at 30 bar |
| Sample^{a} | (wt %)^{b} | (wt %)^{b} | (wt %)^{b} | (wt %)^{b} | S_{BET} (m²g⁻¹) | (cm³g⁻¹)^{c} | and 24° C. (mmol · g⁻¹) |
| Activated | 94.10 | 5.90 | 0.00 | 0.00 | 845 | 0.43 | 8.45 |
| charcoal | | | | | | | |
| BPL^{d} | 91.3 | 8.7 | 0.00 | 0.00 | 951 | 0.49 | 8.66 |
| SD-600-4 | 82.24 | 15.80 | 0.00 | 0.00 | 2290 | 1.10 | 20.52 |
| SD-800-4 | 89.96 | 8.03 | 0.00 | 0.00 | 2850 | 1.35 | 22.90 |
| CN-600-2 | 88.13 | 11.87 | 0.00 | 0.00 | 1250 | 0.64 | 13.50 |
| PPy-500-2 | 72.47 | 17.19 | 10.33 | 0.00 | 1255 | 0.53 | 12.60 |
| PPy-600-2 | 74.78 | 19.72 | 5.49 | 0.00 | 2013 | 1.03 | 18.98 |
| PPy-700-2 | 90.01 | 9.87 | 0.14 | 0.00 | 2956 | 1.45 | 22.98 |
| PPy-800-2 | 91.39 | 8.60 | 0.00 | 0.00 | 3230 | 1.51 | 21.01 |
| PPy-800-4 | 90.78 | 9.11 | 0.10 | 0.00 | 3450 | 2.57 | 22.10 |
| PAn-600-3 | 84.50 | 6.75 | 8.75 | 0.00 | 1410 | 1.38 | 14.50 |
| SD-M-800-4 | 85.39 | 8.15 | 6.46 | 0.00 | 2990 | 2.69 | 23.80 |
| PTh-600-2 | 64.91 | 25.88 | 0.00 | 9.21 | 2256 | 1.02 | 18.81 |
| PTh-700-2 | 82.47 | 13.01 | 0.00 | 4.51 | 1980 | 0.99 | 20.32 |
| PTh-800-2 | 88.18 | 7.24 | 0.00 | 4.58 | 2890 | 1.43 | 22.87 |

^{a}Precursor-temperature-KOH:precursor ratio.
^{b}Determined by XPS.
^{c}Determined at P/Pₒ ~0.99.
^{d}Purchased from Calgon Carbon Corp.

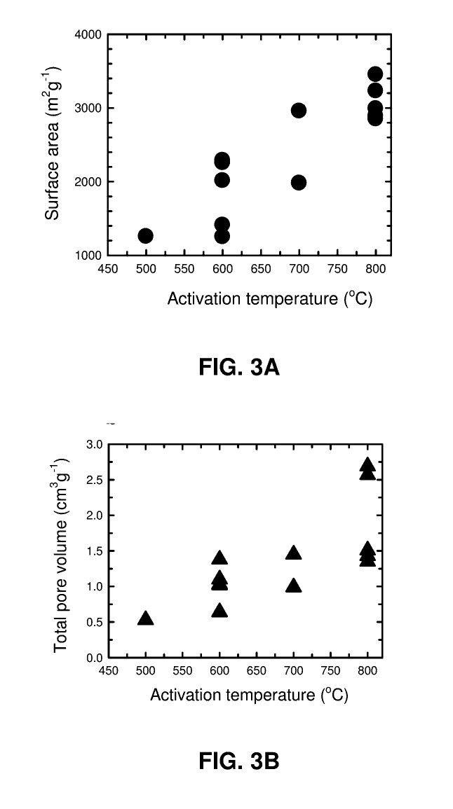

Given the relationships between surface area and pore volume with CO₂ uptake, it is not surprising that their relationship with activation temperature is also similar (FIG. 3). The analysis of a series of samples prepared from N-containing polymer polypyrrole (PPy) at different activation temperatures (i.e., PPy-T-2), but otherwise under identical conditions, allows for a convenient direct comparison of the effects of temperature.

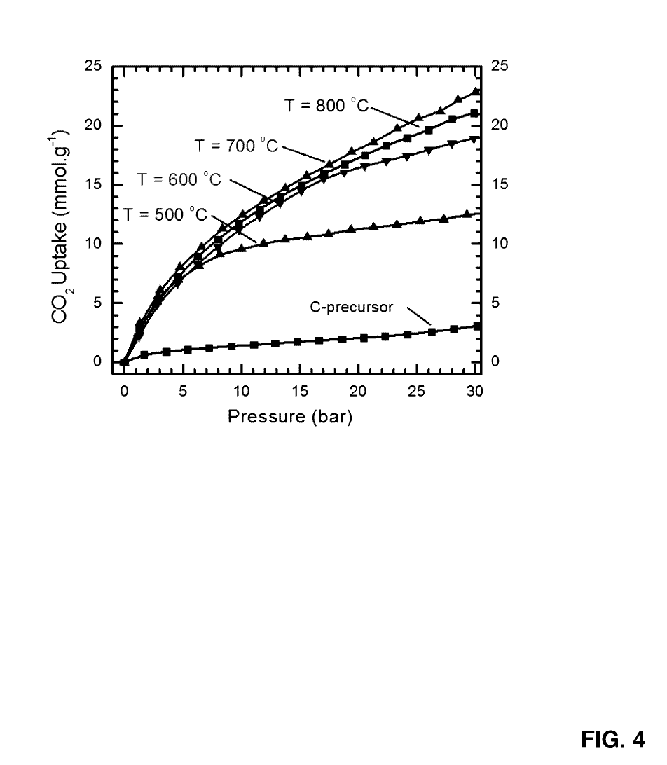

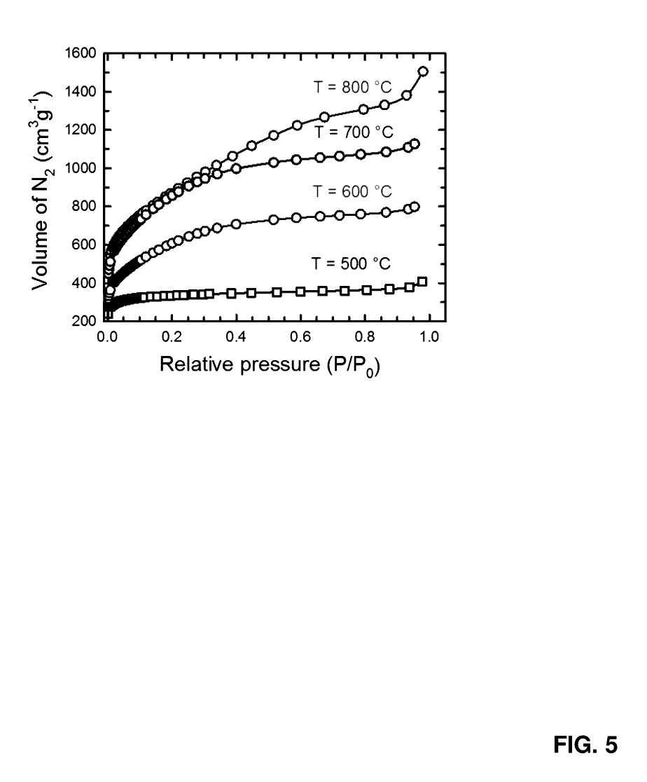

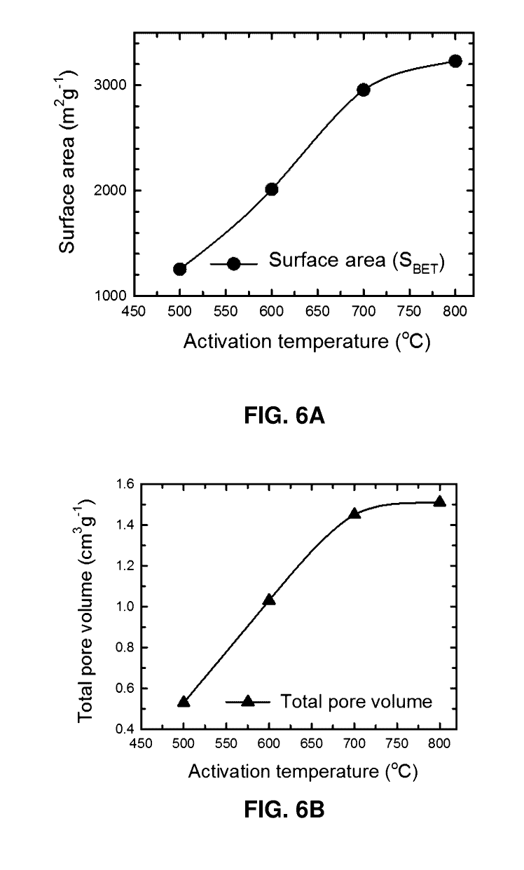

The CO₂ uptake plot for each sample as a function of CO₂ pressures is shown in FIG. 4, whereas FIG. 5 shows their corresponding N₂ adsorption isotherms at 77 K. It may be noticed that the shape of these isotherms is dependent on the activation temperature. The isotherm for PPy-800-2 is much steeper than that of PPy-500-2 between relative pressures of 0.4 and 1.0, indicating the variation in mesoporosity and adsorption capacity. For the homologous series of NPC materials, the estimated surface area (S_{BET}) and the total pore volume (Vₚ) gradually increase with activation temperature (FIGS. 6A-B), describing the incremental trend for mildly to strongly activated samples. Between 500 and 700° C., the surface area and total pore volume increases systematically, whereas for temperatures above 700° C. no significant increment is noticed.

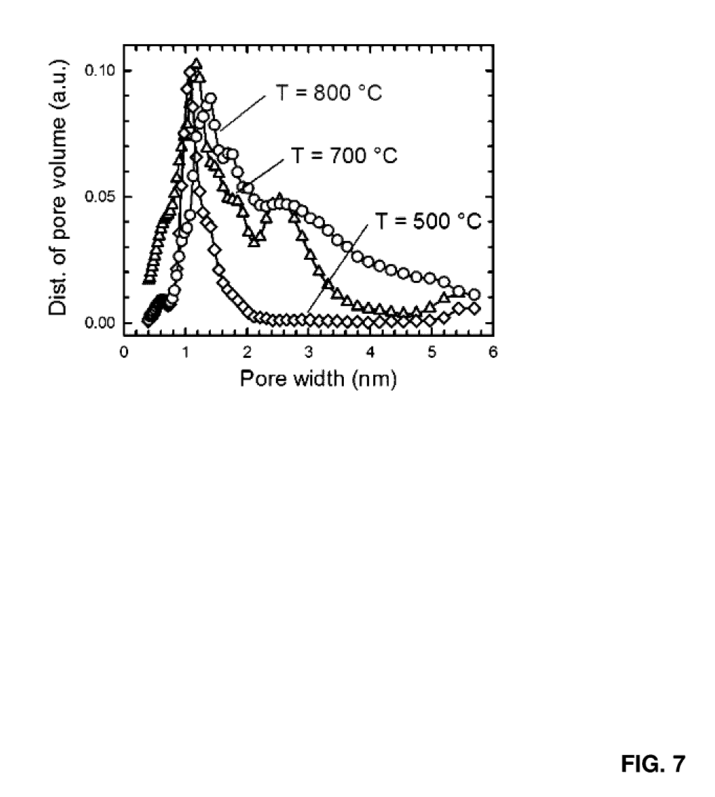

Besides the surface area and pore volume, another important characteristic that can be obtained from the N₂ adsorption isotherms is the pore size distribution (PSD) of the porous solid. FIG. 7 depicts the PSDs for three different PPy-based PCs prepared under mild (T=500° C.) to strong (T=800° C.) activation conditions. The distribution plot for T=500° C. indicates that the activated PC mainly consists of micropores in the 1-2 nm range, whereas the plot for PPy-700-2 clearly shows signature of some larger pores in the 2-3.5 nm range. The most strongly activated PC and PPy-800-2 even shows a significant number of mesopores in the 3-6 nm range, in agreement with the steeper adsorption registered for relative pressures of more than 0.4.

A comparison of the variation in pore size and distribution (FIG. 7) with the CO₂ uptake for the same samples (FIG. 4 and Table 1) was also made. From 500° C. to 700° C., there is a dramatic increase in the high pressure uptake, which can be associated with the generation of pores in the range of 2-3 nm. However, as may be seen from FIG. 4, there is a slight (but significant) decrease upon further activation to 800° C., even though there is an increase in the presence of larger pores. This suggests that larger pores are not necessarily ideal for a high CO₂ adsorption. The pore size distribution for the other top adsorbents studied shows a similar bi-modal pore structure centered on 1 nm and 1.5-2 nm.

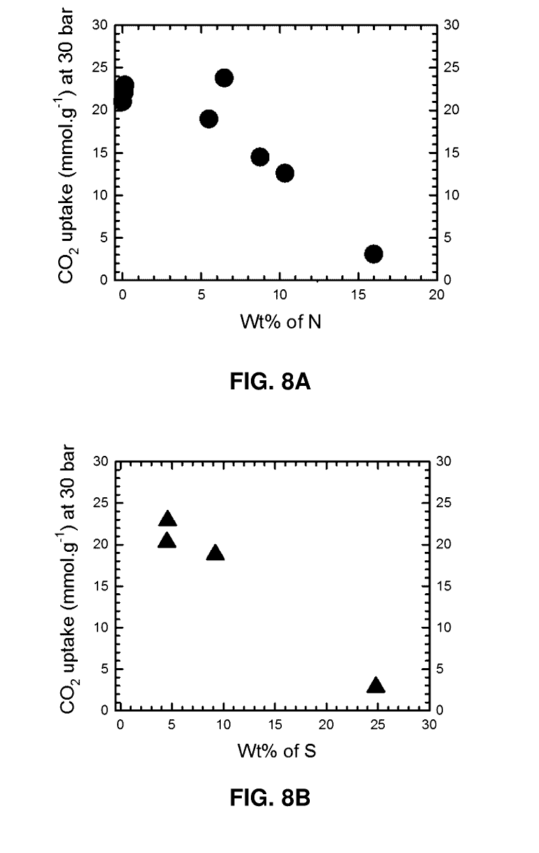

The CO₂ uptake for NPC and SPC samples as a function of their N or S content is shown in FIG. 8. For both NPC and SPC samples, the CO₂ uptake is at a maximum with the heteroatom content of less than 5 wt %. Based upon these results, it would appear that the presence of neither N nor S correlates in a positive manner with the CO₂ uptake, although in the present case a higher heteroatom content is associated to lower surface area and pore volume, hence the corresponding lower CO₂ uptake. Nonetheless, the limited effect of the presence of heteroatoms on CO₂ uptake is in line with previous results, and Applicants' proposal that the presence of N or S is not responsible for any stabilization of poly-CO₂ that has been proposed to be responsible for high CO₂ adsorption at 30 bar.

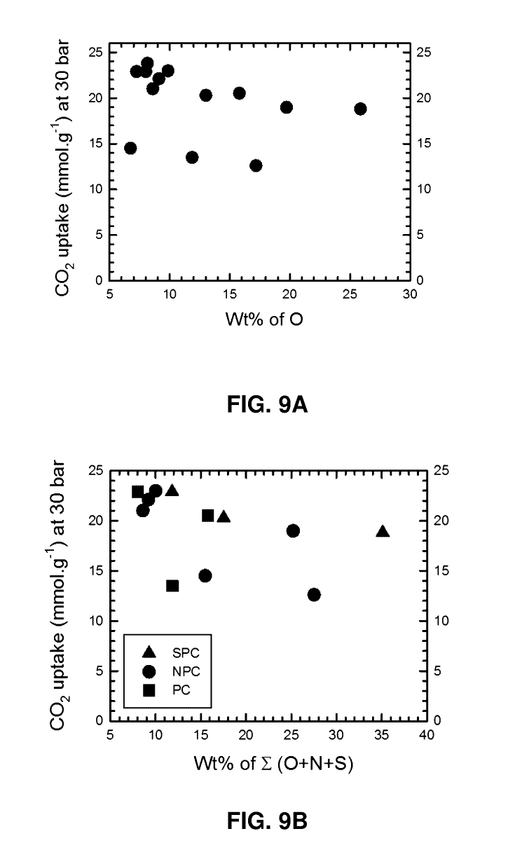

Both NPC and SPC samples contain significant O, as do the PC samples produced from non-heteroatom containing precursors. Given that some of the PC samples perform in a comparable manner to those of NPC or SPC, N and S composition cannot be the sole key to high adsorption. While the presence of more than 5 wt % of either N or S appears to significantly lower the uptake of CO₂, although this could be related to the lower surface area of the heteroatom-rich samples, the O content is far more effective for the high CO₂ adsorption observed with 3-16 wt % O (FIG. 9A).

In support of this observation, there are also some significant findings on the CO₂ capture capacity of activated PCs obtained from the carbonization of asphalt with KOH. The reduction with H₂ of asphalt-derived N-doped PCs causes a significant increase of capture capacity up to 26 mmol·g⁻¹. The XPS elemental analysis of the sample before and after H₂ treatment shows that the sample with higher CO₂ capacity undergoes a significant increase of O content while the N content and type is only slightly changed. This finding supports Applicants' hypothesis that O plays a major role in establishing the CO₂ capture capacity of PCs. However, what appears to be more important is the combined presence of a heteroatom (i.e., Σ(O, N, S), FIG. 9B). This can be alternatively stated that the C content should be between 80-95 wt %.

Based upon the forgoing, it is possible to identify the parameters that define a PC material for maximum CO₂ uptake: have a surface area>2800 m²g⁻¹, a pore volume>1.35 cm³g⁻¹, and a C content between 80-95 wt %. To achieve these performance parameters it is necessary to activate above 700° C. and to ensure full mixing of the KOH with the precursor. It is significant that the first two of these suggest that developing higher and higher surface area materials is unproductive, and that understanding the third may lead to the design of new PC materials. Furthermore, these values offer additional variance when the uptake of CO₂ is required at lower pressures.

Applicants have also investigated the CO₂/CH₄ selectivity by measuring CO₂ and CH₄ uptake isotherms up to a high pressure limit of 10, 20 and 30 bar at 24° C. A summary of the data is shown in Table 2.

TABLE 2
Summary of PC, NPC, and SPC samples studied with their molar gas uptakes and selectivity for
CO₂ over CH₄ at different uptake pressures.

| | CO₂ uptake | | | CH₄ uptake | | | Molar (CO₂:CH₄) uptake | | |
|---|---|---|---|---|---|---|---|---|---|
| | (mmol · g⁻¹) at | | | (mmol · g⁻¹) at | | | ratio | | |
| Sample^{a} | 10 bar | 20 bar | 30 bar | 10 bar | 20 bar | 30 bar | 10 bar | 20 bar | 30 bar |
| Activated | 6.27 | 7.51 | 8.45 | 4.28 | 5.44 | 6.03 | 1.46 | 1.38 | 1.41 |
| charcoal | | | | | | | | | |
| BPL | 6.30 | 7.87 | 8.66 | 3.24 | 4.96 | 6.18 | 1.94 | 1.59 | 1.40 |
| SD-600-4 | 12.06 | 16.77 | 20.52 | 5.23 | 7.54 | 8.52 | 2.31 | 2.22 | 2.41 |
| SD-800-4 | 13.61 | 18.78 | 22.90 | 6.65 | 9.45 | 10.92 | 2.05 | 1.99 | 2.10 |
| CN-600-2 | 10.91 | 12.65 | 13.50 | 5.94 | 7.24 | 7.96 | 1.83 | 1.74 | 1.70 |
| PPy-500-2 | 9.51 | 11.27 | 12.60 | 4.11 | 5.06 | 5.98 | 2.31 | 2.23 | 2.11 |
| PPy-600-2 | 11.37 | 16.45 | 18.98 | 5.39 | 6.33 | 7.41 | 2.11 | 2.60 | 2.56 |
| PPy-700-2 | 12.50 | 18.12 | 22.98 | 5.75 | 7.92 | 9.41 | 2.17 | 2.29 | 2.44 |
| PPy-800-2 | 11.94 | 17.21 | 21.01 | 5.78 | 8.23 | 9.82 | 2.07 | 2.09 | 2.14 |
| PPy-800-4 | 11.18 | 16.51 | 22.11 | 5.10 | 7.33 | 8.83 | 2.19 | 2.25 | 2.50 |
| PAn-600-3 | 8.19 | 10.84 | 14.50 | 4.04 | 5.26 | 6.03 | 2.03 | 2.06 | 2.40 |
| SD-M-800-4 | 12.09 | 18.70 | 23.76 | 5.58 | 8.12 | 9.41 | 2.17 | 2.30 | 2.52 |
| PTh-600-2 | 11.17 | 15.42 | 18.81 | 4.77 | 6.12 | 7.37 | 2.34 | 2.52 | 2.55 |
| PTh-700-2 | 11.51 | 16.67 | 20.32 | 4.62 | 6.87 | 8.01 | 2.49 | 2.43 | 2.54 |
| PTh-800-2 | 13.10 | 18.80 | 22.87 | 5.81 | 8.55 | 10.14 | 2.25 | 2.20 | 2.26 |

^{a}Precursor-temperature-KOH:precursor ratio.

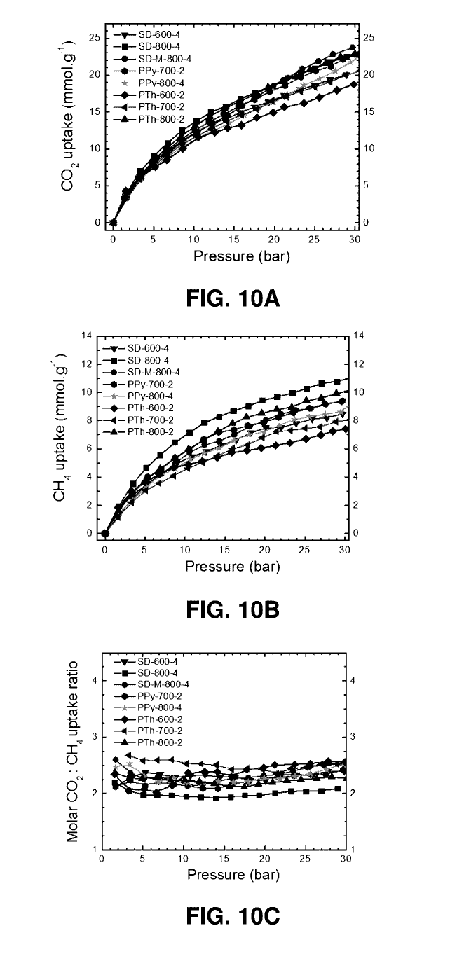

FIG. 10A shows the CO₂ uptake plots along with the corresponding CH₄ uptake results in FIG. 10B. Additionally, the molar uptake selectivity (CO₂/CH₄) is defined by the molar ratio of adsorbed CO₂ and CH₄ at a certain pressure, i.e., at 30 bar. The dependence of molar uptake selectivity for a sorbent as a function of corresponding gas pressure is depicted in FIG. 10C. It is significant that for any particular sample, the selectivity varies with gas pressure. Of the samples investigated, PPy-600-2 demonstrated highest selectivity of 2.56 at 30 bar.

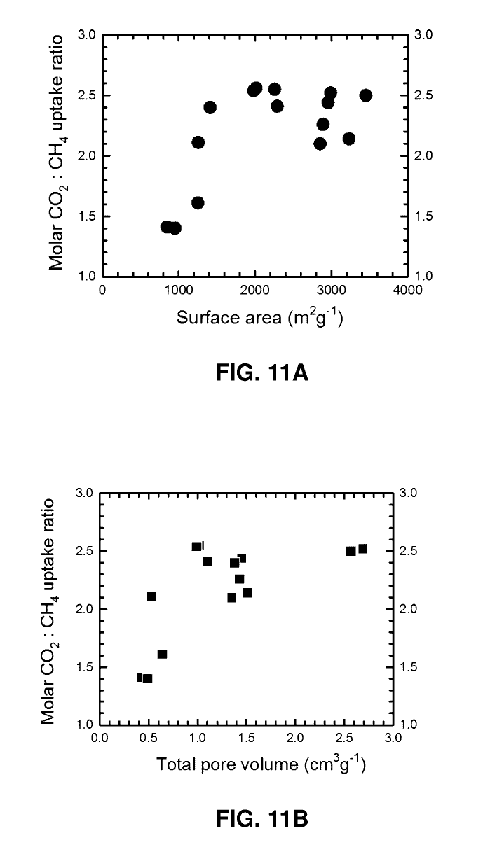

FIG. 11A shows a plot of molar CO₂:CH₄ uptake ratio as a function of the surface area (S_{BET}) for all the PC adsorbents measured. For low surface area samples, there is an increase in selectivity with increased surface area. However, as with uptake, further increase in surface area above 2000 m²g⁻¹ does not appear to improve selectivity. In a similar manner, increased total pore volume (Vₚ) does facilitate increased selectivity, but only to a pore volume of 1.00 cm³g⁻¹. No improvement in performance is shown above the aforementioned value (FIG. 11B).

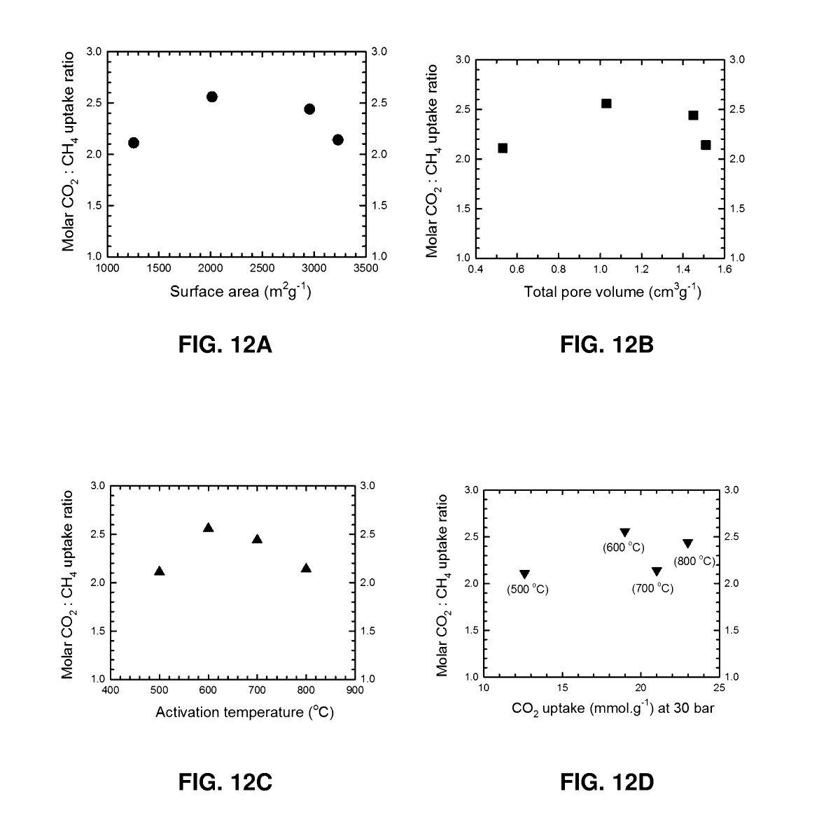

The series PPy-T-2 (T=500-800° C.) allows for the direct comparison of homologous materials. In this case, it appears that the values of 2,000 m²g⁻¹ and 1.00 cm³g⁻¹ for the surface area and total pore volume (FIG. 12) represent maxima rather than thresholds. It is possible that for any homologous series similar maxima are observed. However, the thresholds observed in FIG. 11 are useful indicators.

From Table 2, it can be seen that an activation temperature of 600° C. is a minimum for good selectivity. However, from FIG. 12C, it may be seen that for the series PPy-T-2 (T=500-800° C.), this value is actually an optimum. Such results may vary with a particular class of material. However, a lower activation temperature is required to create a material with good selectivity as compared to optimum CO₂ uptake (FIG. 12D), suggesting that the best attainable sorbent material will have to combine a wise trade off of selectivity and CO₂ capture capacity. As may be seen from a comparison of PPy-800-2 and PPy-800-4 (Table 2), increased KOH concentration during the activation step results in greater selectivity.

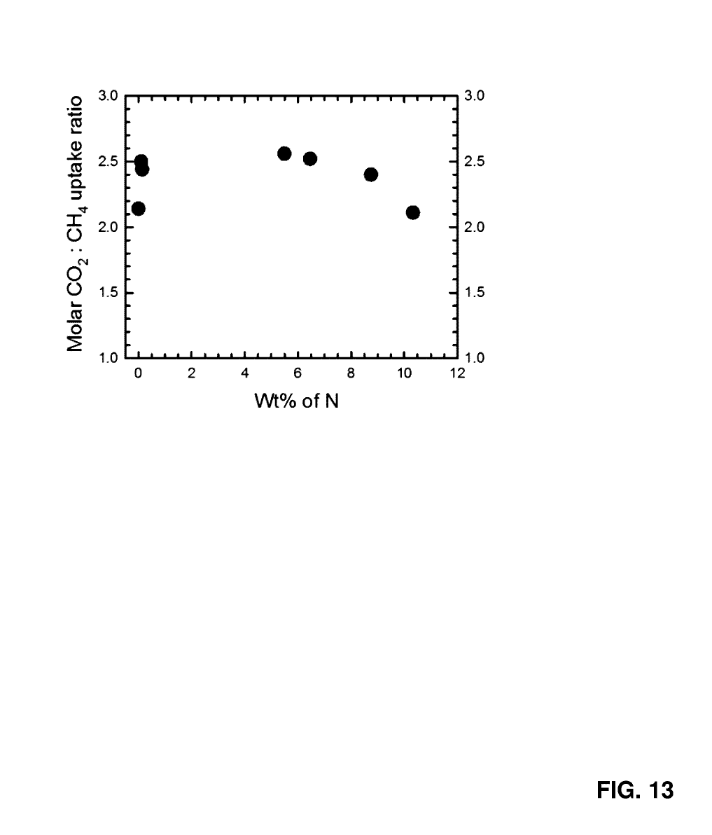

The molar CO₂:CH₄ uptake ratio for NPC samples as a function of their N content is shown in FIG. 13. The selectivity for measurements at 30 bar decreases with N content above 5 wt %. In the case of SPC, there appears to be no effect on selectivity with S content (Tables 1 and 2).

These results seem to suggest that the presence of neither N nor S correlates in a direct manner with the CO₂/CH₄ selectivity. This is in line with Applicants' previous proposal. However, in this Example, a higher heteroatom content implies a lower surface area (and total pore volume) of the sorbent materials. Hence, a definite lack of impact of N or S doping on the selectivity performance of PCs cannot be considered a priori. Significantly, as may be seen from the data in Table 2, at lower pressures (10 bar), there is almost no dependence between selectivity and heteroatom content.

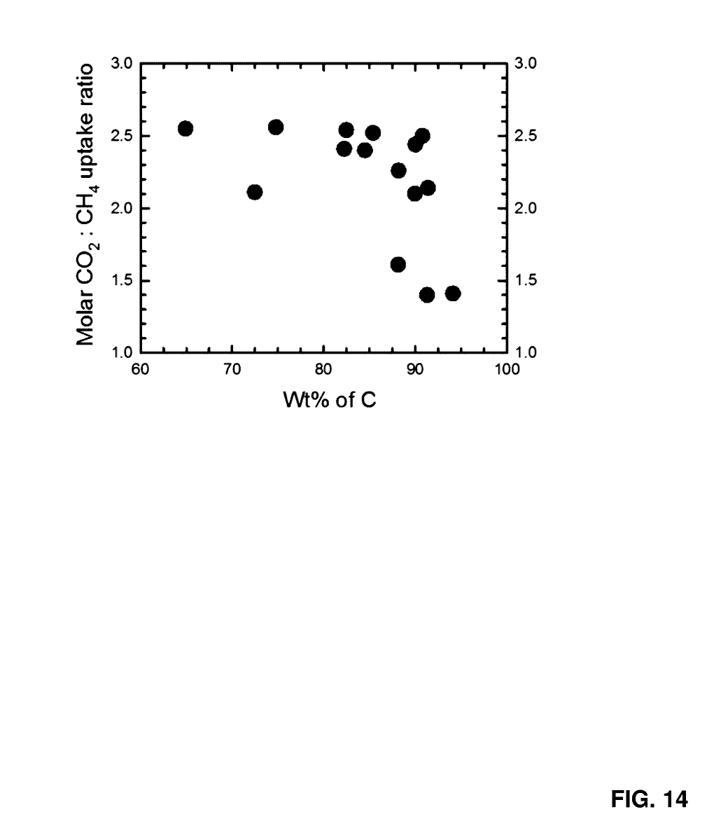

As was observed with the uptake efficiency for CO₂, the selectivity appears to be more a function of the total heteroatom composition (i.e., Σ(O, N, S) wt %, as presented in FIG. 14 in terms of C wt % (=100−Σ(O, N, S) wt %)). However, based upon the analysis of all the PC, NPC, and SPC materials studied, the 0 wt % seems to be the major contributor. The CO₂/CH₄ selectivity is at a potential maximum as long as C content is below 90 wt % (i.e., for Σ(O, N, S)>10 wt %). At lower pressure (10 bar), the carbon content is possibly even higher (C<94 wt %).

A study of a wide range of PC, NPC, and SPC materials under high pressure CO₂ and CH₄ adsorption offers some useful insight into the parameters that may collectively control both the CO₂ uptake efficiency and the CO₂/CH₄ selectivity. A summary of the proposed key requirements for a PC material with either good CO₂ uptake or good CO₂/CH₄ selectivity is given in Table 3 based on the results presented herein.

TABLE 3
Summary of proposed parameters required for optimum
CO₂ uptake and CO₂/CH₄ selectivity for PC, NPC, and SPC.

| Parameter | Uptake @ 30 bar | Selectivity @ 30 bar |
|---|---|---|
| Surface area (m² g⁻¹) | >2800 | >2000 |
| Total pore volume (cm³ g⁻¹) | >1.35 | >1.0 |
| Temperature of activation (° C.) | 700-800 | 600 |
| Carbon content (%) | 80-95 | <90 |

As far as CO₂ uptake is concerned, any porous carbon material with a surface area of more than 2800 m²g⁻¹ at 30 bar is unlikely to be improved (when prepared from the KOH activation of non-nanostructured precursors). A similar threshold appears to be true for the total pore volume of the material (1.35 cm³g⁻¹). This suggests that seeking synthetic routes to ever higher surface area and/or high pore volume PC-based adsorbents is counterproductive.

However, it should be understood that if uptake at lower pressures is desired, these threshold values decrease even further. This result is highly important in considering the choice of adsorbent to be used in a large scale unit. The adsorbent intended for use in a low pressure system needs a lower surface area and pore volume to perform than a potentially more expensive to manufacture material. It also impacts the formation of pelletized materials for adsorbent bed applications, since the formation of the pellet through inclusion of a binder inevitably lowers the surface area and pore volume. Applicants' results suggest that for lower pressure applications, this is not important since the uptake is less dependent on extremely high surface areas and/or pore volumes.

Given the prior interest in N- and S-doped PC materials, the results show that CO₂ uptake is inversely related to S and N content in SPC and NPC, respectively. However, due to the preparation process used in this Example (KOH activation), there is an intrinsic dependence between heteroatom content and surface area (total pore volume) in all sorbents. In particular, higher surface areas imply lower N or S contents.

Consequently, the use of KOH activated PCs in industrial scale units must take into account that a higher heteroatom content cannot offset the corresponding drop of CO₂ capture performance due to a decrease of surface area of the materials. In practical terms, it is the Σ(O, N, S) wt % or C wt % (=100−Σ(O, N, S) wt %) that is the defining factor for CO₂ uptake. This is true irrespective of the source of the heteroatom. However, O appears to be the main factor, since a C content of between 80 and 95 wt % offers the potential for high CO₂ uptake. However, at these levels, if the make-up is N or S, the uptake is likely reduced. It should also be observed based upon the source of the heteroatom that if heteroatoms are to be incorporated and “active”, they are preferentially included using heterocycle precursors, such as melamine in the case of N, rather than other heteroatom-rich structures.

It may be assumed that the parameters that makes a good CO₂ adsorbent may be the same as those that make a selective material. However, Applicants' results indicate that the two are only broadly related. The levels of surface area and pore volume can be even lower for good CO₂/CH₄ selectivity, as compared to CO₂ uptake (Table 3).

In summary, Applicants demonstrate in this Example that a synthetic goal for PC-based material, for both high CO₂ adsorption and high CO₂/CH₄ selectivity, would comprise a C content of less than 90%. Given that neither N nor S seem to have a significant effect rather than the O that is present, it is clear that a design CₓO₁₋ₓ where x<0.9 would possibly make an ideal CO₂ adsorbent material with the best CO₂/CH₄ selectivity. Furthermore, the goal should be a precursor where oxygen is incorporated into a cyclic moiety.

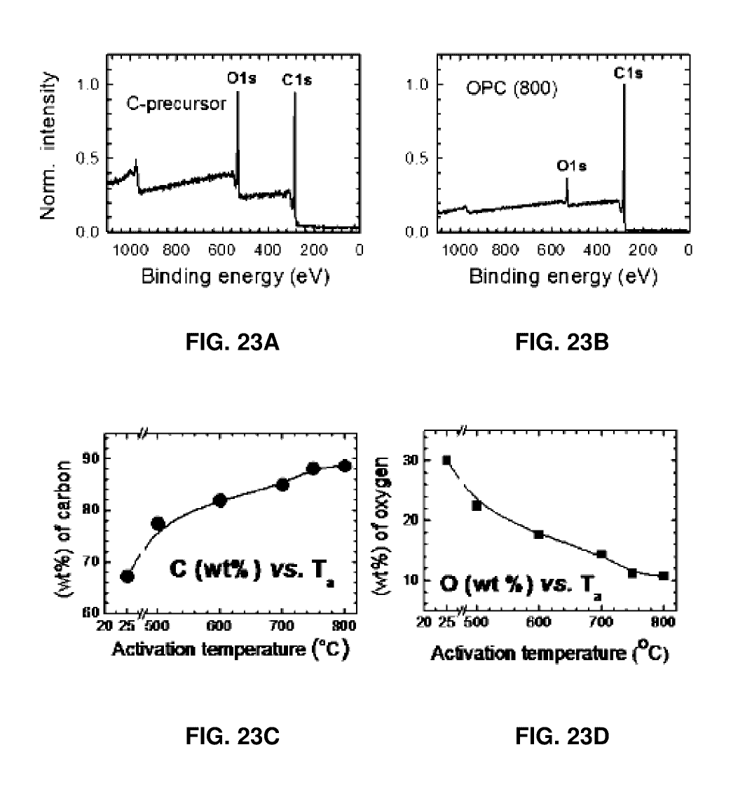

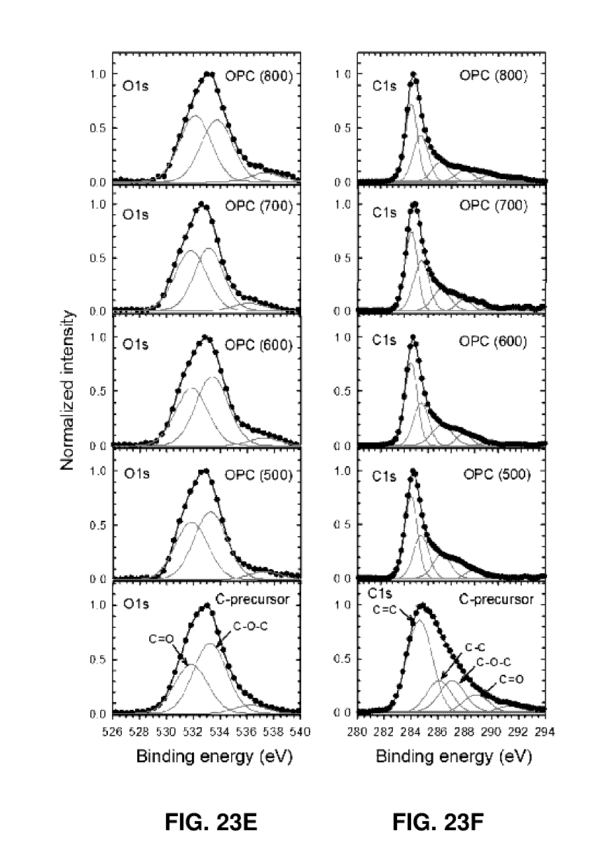

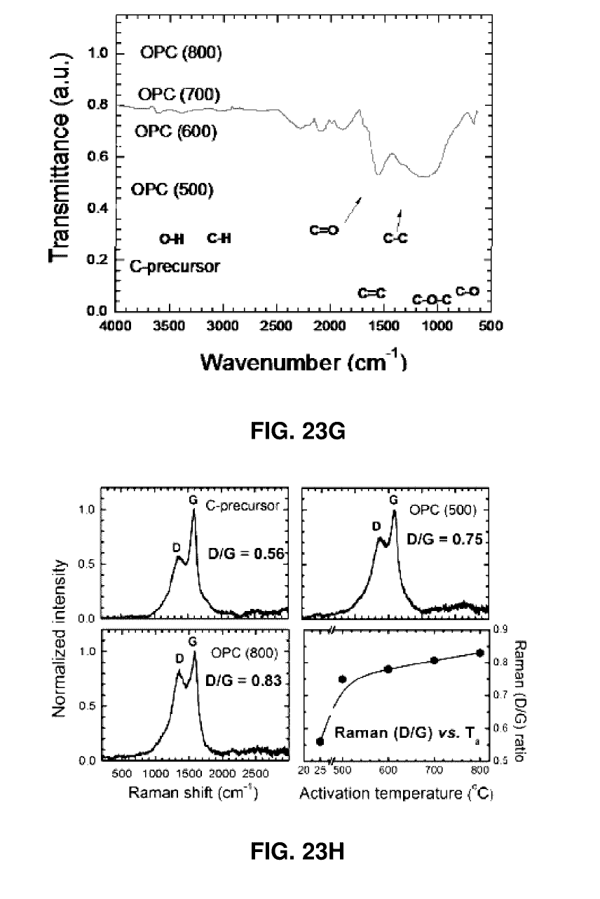

Additional experimental results and information are provided in FIGS. 15-23 and Tables 4-6. For instance, the chemical composition of OPC (750) has been thoroughly characterized via XPS, FTIR and Raman spectroscopy (FIG. 23 and Table 6), while textural properties were determined by high resolution scanning electron microscopy (FIGS. 21E-H), transmission electron microscopy (FIGS. 21I-J) and a BET Surface area analyzer (FIG. 16). Moreover, measured values for gas uptakes have been confirmed via volumetric, gravimetric, multiple sample and cycles experiments.

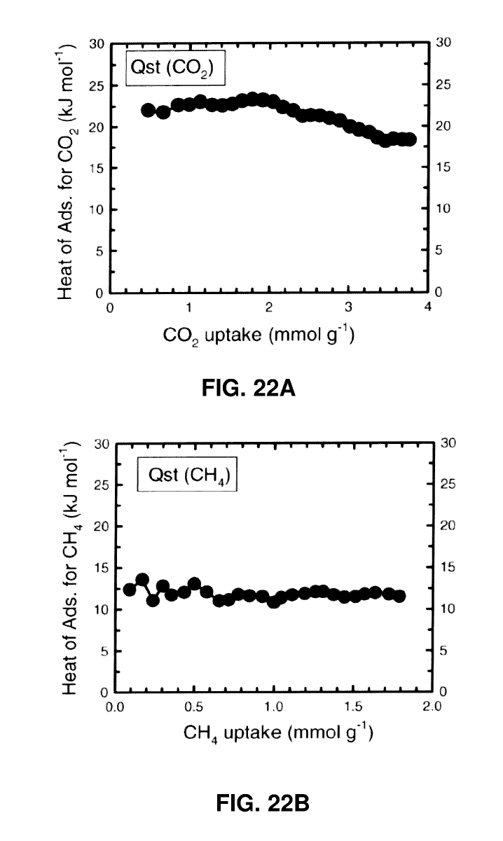

To the best of Applicants' knowledge, oxygen-rich carbon materials prepared from furfuryl alcohol has never been investigated for high pressure uptake of CO₂ and CH₄. In fact, there have been no reports of its use as a precursor for oxygen-rich porous carbon materials. In addition, a higher value for the isosteric heat of adsorption of CO₂ (23 kJ·mol⁻¹) versus 13 kJ·mol⁻¹ for CH₄ allows Applicants to scheme a temperature dependent strategy for removing CO₂ from natural gas via selective adsorption and desorption of CH₄ and CO₂ in steps (FIG. 22).

TABLE 4
Survey of different c-feedstock used for the synthesis
of various PCs with high CO₂ uptake properties.

| | | | | | Maximum CO₂ |
|---|---|---|---|---|---|
| | | | | | uptake at 30 |
| PC | Source material for | | SKU pack size | | bar (mmol |
| sample | C-precursor | CAS no. | (Sigma Aldrich) | Price | g⁻¹) (wt %) |
| SPC (1) | 2- | 636-72-6 | 181315-100 G | $155 for 100 g | 18.4 (81) |
| | Thiophenemethanol | | | | |
| SPC (2) | Thiophene | 110-02-1 | T31801-500 G | $47 for 500 g | — |
| NPC (1) | Pyrrole | 109-97-7 | W338605-1 KG | $315 for 1 kg | — |
| NPC (2) | Polyacrylonitrile | 25014-41-9 | 181315-100 G | $190 for 100 g | 16.8 (74) |
| OPC (l) | Furfuryl alcohol | 98-00-0 | W249106-25 KG | $60 for 1 kg | 26.6 (117) |
| | | | | ($354 for 25 kg) | |
| OPC (2) | Furan | 110-00-9 | 185922-500 ML | $54 for 500 mL | — |

TABLE 5
Survey of gas adsorption properties of various PCs with high CO₂ uptake capacity.

| | | | | | | | | Ratio of | |
|---|---|---|---|---|---|---|---|---|---|
| | | Uptake of Co₂ | | Uptake of CO₃ | | Uptake of CH₄ | | absorbed | |
| | Surface | at 30 bar | | at 10 bar | | at 30 bar | | CO₂/CH₄ | |
| | area S_{BET} | (mmol · g⁻¹) | | (mmol · g⁻¹) | | (mmol · g⁻¹) | | at 30 bar | |
| Sample | (m² g⁻¹) | (wt %) | | (wt %) | | (wt %) | | (molar) (mass) | |
| C-Precursor | 48 | 3.3 | (14.5) | 1.6 | (7.0) | — | | — | |
| OPC (500) | 1143 | 17.1 | (75.2) | 8.6 | (37.8) | 6.7 | (10.7) | 2.5 | (7.0) |
| OPC (600) | 2116 | 20.0 | (88.1) | 12.5 | (55.0) | 8.3 | (13.3) | 2.3 | (6.3) |
| OPC (700) | 2610 | 20.8 | (91.5) | 12.7 | (55.9) | 9.1 | (14.6) | 2.3 | (6.2) |
| OPC (750) | 2856 | 26.6 | (117.0) | 15.1 | (66.4) | 9.6 | (15.5) | 2.75 | (7.5) |
| OPC (750) | 2856 | 42.9 | (188.9) | 18.5 | (81.5) | 14.6 | (23.4) | 2.93 | (8.0) |
| at 0.5° C. | | | | | | | | | |
| OPC (800) | 3005 | 23.0 | (101.2) | 12.9 | (56.7) | 9.01 | (14.4) | 2.5 | (7.0) |
| SPC ^{a} | 2500 | 18.4 | (81.0) | 10.0 | (44.0) | 7.1 | (11.3) | 2.6 | (7.1) |
| r-NPC ^{a} | 1450 | 16.8 | (74.0) | 7.1 | (31.2) | 7.6 | (12.2) | 2.2 | (6.1) |
| Act. charcoal | 845 | 8.4 | (36.9) | 6.3 | (27.7) | 6.0 | (9.6) | 1.4 | (3.8) |

TABLE 6
Elemental composition of various types porous carbon materials as
determined by XPS excluding the contribution from elemental H.

| | C | O | | Surface | Total pore |
|---|---|---|---|---|---|
| | (wt %) | (wt %) | KOH: | area S_{BET} | volume V_{P} |
| Sample | XPS | XPS | precursor | (m² g⁻¹) | (cm³ g⁻¹) |
| C-Precursor | 69.91 | 30.09 | — | 48 | 0.02 |
| OPC (500) | 77.49 | 22.51 | 3:1 | 1143 | 0.78 |
| OPC (600) | 82.04 | 17.74 | 3:1 | 2216 | 1.19 |
| OPC (700) | 85.07 | 14.93 | 3:1 | 2610 | 1.46 |
| OPC (750) | 88.21 | 11.79 | 3:1 | 2856 | 1.77 |
| OPC (800) | 89.28 | 10.72 | 3:1 | 3005 | 1.92 |
| Act. charcoal | 94.10 | 5.90 | 3:1 | 845 | 0.43 |

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A material for CO₂ adsorption at pressures above 1 bar, said material comprising:
a porous carbon material with a surface area of at least 2800 m²/g, a total pore volume of at least 1.35 cm³/g, and a carbon content of between 80% and 95% as measured by X-ray photoelectron spectroscopy,
wherein the porous carbon material is prepared by heating an organic polymer precursor or biological material in the presence of KOH, and
wherein the temperature of activation is between 700° C. and 800° C.

2. The material of claim 1, wherein the porous carbon material is prepared by heating an organic polymer precursor.

3. The material of claim 2, wherein the organic polymer precursor comprises oxygen in a functional group.

4. The material of claim 3, wherein the functional group is a furyl.

5. The material of claim 4, wherein the organic polymer precursor polymerizes to form polyfurfuryl alcohol.

6. The material of claim 5, wherein the polyfurfuryl alcohol is prepared by the polymerization of furfuryl alcohol with a catalyst.

7. The material of claim 6, where the catalyst is iron(III) chloride.

8. The material of claim 1, wherein the porous carbon material is prepared by heating a biological material.

9. The material of claim 8, where the biological material is selected from the group consisting of sawdust, coconut husk, and combinations thereof.

10. A material for the separation of CO₂ from natural gas at partial pressures of either component above 1 bar, said material comprising:
a porous carbon material with surface area of at least 2000 m²/g, a total pore volume of at least 1.00 cm³/g, and a carbon content of greater than 90% as measured by X-ray photoelectron spectroscopy,
wherein the porous carbon material is prepared by heating an organic polymer precursor or biological material in the presence of KOH, and
wherein the temperature of activation is between 600° C. and 700° C.

11. The material of claim 10, wherein the porous carbon material is prepared by heating an organic polymer precursor.

12. The material of claim 11, wherein the organic polymer precursor contains oxygen in a functional group.

13. The material of claim 12, wherein the functional group is a furyl.

14. The material of claim 13, wherein the organic polymer precursor polymerizes to form polyfurfuryl alcohol.

15. The material of claim 14, wherein the polyfurfuryl alcohol is prepared by the polymerization of furfuryl alcohol with a catalyst.

16. The material of claim 14, wherein the catalyst is iron(III) chloride.

17. The material of claim 10, wherein the porous carbon material is prepared by heating a biological material.

18. The material of claim 17, where the biological material is selected from the group consisting of sawdust, coconut husk, and combinations thereof.
